(19) United States
(12) Patent Application Publication
(10) Pub. No.: US 2024/0367532 A1
(43) Pub. Date: Nov. 7, 2024

(54) SYSTEMS, METHODS, AND RELATED CHARGING STRUCTURES FOR INSTALLATION OF ELECTRIC OUTLETS

(71) Applicant: GOPOWEREV INC., Palo Alto, CA (US)

(72) Inventor: John Reister, Palo Alto, CA (US)

(21) Appl. No.: 18/567,942

(22) PCT Filed: Jun. 14, 2022
(86) PCT No.: PCT/US2022/072921

§ 371 Date: Dec. 7, 2023

Related U.S. Application Data
(60) Provisional application No. 63/210,896, filed on Jun. 15, 2021.

(51) Int. Cl. B60L 53/30

(52) U.S. Cl. CPC B60L 53/30

(57) ABSTRACT

An electric vehicle charging structure can include a base portion including a front surface and a rear surface, a base compartment that is rigidly coupled to the base portion, the base compartment defined by a base compartment upper surface and a base compartment lower surface that each protrude away from the front surface of the base portion, an electrical connector passing through the base compartment upper surface at a specified location, a conduit entry opening in the base compartment configured to allow insertion of electrical service conductors to inside the base compartment, a power terminal inside the base compartment, the power terminal configured to removably secure the electrical service conductors, and an internal electrical conductor inside the base compartment electrically coupling the power terminal to the electrical connector.

### CROSS-REFERENCE TO RELATED APPLICATIONS

The present application claims priority to U.S. Provisional Patent Application Ser. No. 63/210,896, titled Systems, Devices, Applications, and Related Methods Including Attaching, Wiring, Indoor Or Outdoor Electric Outlet Enclosures, filed in the USPTO on Jun. 15, 2021, the entire content of which is hereby incorporated herein by reference.

### FIELD

Embodiments according to the inventive concept relate to electric outlets for both indoor and water-resistant outdoor locations.

### BACKGROUND

An electric vehicle charging station may be installed by an electrical contractor in multiple steps. Each of those steps may entail performing a specific task such as the rough-in, where the contractor runs electrical wiring to a junction box via a conduit which is then sealed. An inspection of the rough-in work may, however, need to be performed before the electric vehicle charging outlet can be installed (i.e., finished). Furthermore, after the electrical contractor installs the charging outlet, another inspection may be needed before the electric vehicle charging station can be put into service.

### SUMMARY

Embodiments according to the inventive concept can provide systems, devices, applications, and related methods including attaching, wiring, indoor or outdoor electric outlet enclosures. Pursuant to these embodiments, an electric vehicle charging structure can include a base portion including a front surface and a rear surface, a base compartment that is rigidly coupled to the base portion, the base compartment defined by a base compartment upper surface and a base compartment lower surface that each protrude away from the front surface of the base portion, an electrical connector passing through the base compartment upper surface at a specified location, a conduit entry opening in the base compartment configured to allow insertion of electrical service conductors to inside the base compartment, a power terminal inside the base compartment, the power terminal configured to removably secure the electrical service conductors, and an internal electrical conductor inside the base compartment electrically coupling the power terminal to the electrical connector.

In some embodiments according to the present inventive concept, an electric vehicle charging structure can include a main unit including a back surface configured to removably mate in close contact with a front surface of a base portion of an electric vehicle charging structure, a slot in the back surface shaped to allow insertion of first and second ribs and a conduit entry opening of the base portion, in the slot, a plurality of attachment openings protruding from the back surface at locations corresponding to locations of respective attachment openings in a front surface of the base portion, a stepped surface extending horizontally from the back surface, and a main unit electrical connector extending through the stepped surface to an interior of the main unit at a specified location corresponding to a location of a base portion electrical connector, wherein the main unit electrical connector is configured to electrically couple to electrical service conductors secured to a power terminal of the base portion.

In some embodiments according to the present inventive concept, an electric vehicle charging structure can include a base portion of the electric vehicle charging structure having a front surface that includes a base portion electrical connector facing in an upward direction at a first location configured to provide electrical power at the base portion electrical connector upon installation and a main unit of the electric vehicle charging structure having a back surface that includes a main unit electrical connector surface facing in downward direction that is opposite to the upward direction at a second location so that the main unit electrical connector and the base portion electrical connector mate together into close contact when the main unit of the electric vehicle charging structure is lowered onto the base portion.

### BRIEF DESCRIPTION OF THE FIGURES

FIG. 1 is a schematic illustration of a base of an electric vehicle charging structure including a base portion located at an upper part of the base, a base compartment at a lower part of the base and including a channel in the base that extends from the upper part of the base to the base compartment in some embodiments according to the inventive concept.

FIG. 2A is a schematic illustration of the base of the electric vehicle charging structure in FIG. 1 having the base compartment and the channel sealed by respective covers to prevent the exposure of the electrical conductors that extend along the channel into the base compartment in some embodiments according to the inventive concept.

FIG. 2B is a schematic illustration of the base of an electric vehicle charging structure in FIG. 2A including a connector cap that covers an electrical connector that supplies power from inside the base compartment in some embodiments according to the inventive concept.

FIGS. 3A and 3B are schematic illustrations of a back surface of a main unit of the electric vehicle charging structure including an electrical connector on a stepped surface thereof that is configured to mate with the electrical connector in the base compartment shown in FIGS. 1-2 to form the assembled electric vehicle charging structure in some embodiments according to the inventive concept.

FIGS. 4A and 4B are schematic illustrations of the base of FIG. 2 and the main unit of FIG. 3 being mated together to couple the electrical power provided inside the base compartment to a receptacle in the face of the main unit when the respective electrical connectors of the base and the main unit are brought together into close contact to form the electric vehicle charging structure in some embodiments according to the inventive concept.

FIG. 5 is a schematic illustration of the electric vehicle charging structure of FIG. 4 connected to a pole or other structure by straps connected to the base of the electric vehicle charging structure in some embodiments according to the inventive concept.

### DETAILED DESCRIPTION OF EMBODIMENTS ACCORDING TO THE INVENTIVE CONCEPT

Although certain embodiments and examples are described below, it will be understood that the disclosure extends beyond the specifically disclosed embodiments and/or uses and obvious modifications and equivalents thereof. Thus, it is intended that the scope of the disclosure herein disclosed should not be limited by any embodiments described below.

As appreciated by the present inventor, electric outlets with one or more 120V or 240V receptacles or a combination may be installed in indoor or outdoor locations for the support of plug-in electrical devices including electric vehicles (EV), plug-in hybrid electric vehicles (PHEV), electric carts, robotic vehicles, autonomous vehicles or the like. The outlets should be physically mounted and should support wiring from the electrical supply to be connected to the receptacles. The wiring may often be inside electrical conduit, if the wiring running to the outlet is exposed to potential damage, as per electric wiring regulatory codes.

As further appreciated by the present inventor, physical mounting includes many situations encountered by the electrical installation contractor. Some of the situations include (a) outside attachment to an existing cement, brick, wood building wall or retaining wall, (b) outside or inside attachment to an existing square post of various sizes and materials or other type of siding or sheathing material, (c) outside or inside attachment to a round pole or pillar of various sizes and materials, (d) inside or outside attachment to an unfinished (exposed studs) wall, (e) inside attachment to a finished sheetrock or plywood wall. Performing the physical attachment often takes time and cost for the installation contractor, and the geometry or topography of the installation may increase the difficulty of the subsequent task of connecting the wire conductors to the receptacles when installation is completed.

As further appreciated by the present inventor, outlets generally can include an enclosure, receptacles, and a cover. The enclosure can include holes or knockouts to facilitate conduit entry or wiring entry. The holes or knockouts may be threaded and may include a seal against moisture. The cover and area around the receptacles may include a gasket to seal against moisture. The cover may include a secondary cover or door to seal the receptacles against moisture when not in use. The cover may also include a secondary “bubble” cover that can seal the receptacles against moisture when in use.

As further appreciated by the present inventors, an electrical contractor tasked with installing an electric outlet may need to perform a sequence of time-consuming tasks to install the outlet after physical attachment of the outlet enclosure. This includes (a) inserting the wire conductors (one or more hot wires, a neutral wire, and/or a ground wire), (b) securely attaching Conduit (if used) to the enclosure, (c) Stripping and attaching wires to the receptacles via various available means, (d) packing the wires into the enclosure so that they fit neatly without risk of electrical shorts-circuits, (e) physically mounting the receptacles inside the enclosure, (f) installing the gasket and/or cover(s) over the receptacles.

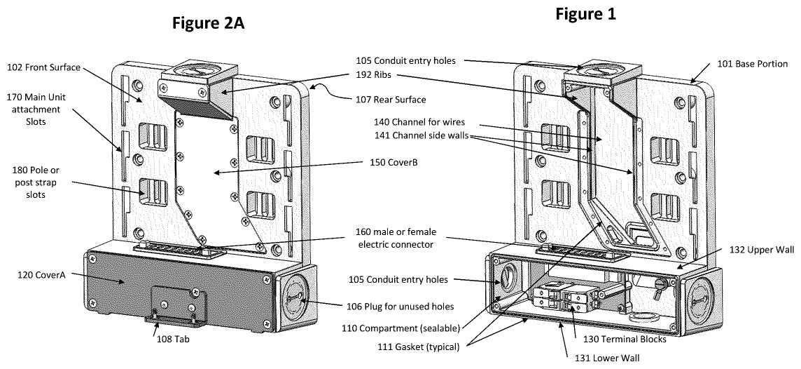

As shown in FIGS. 1-5, in some embodiments according to the inventive concept, an electric vehicle charging structure (sometimes referred to herein collective as an “outlet”) can include a base 100 and a Main Unit 200. The Main Unit 200 is configured to slide into or insert into the base 100, using a pair of male/female electrical connectors 160 and 210 between them to complete installation of the electric vehicle charging structure.

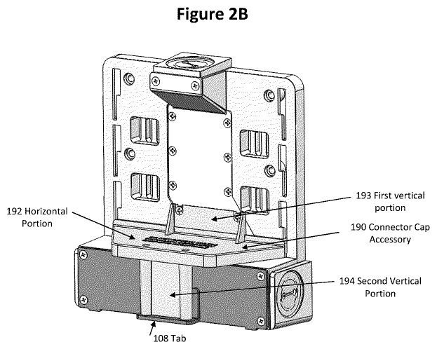

FIG. 1 is a schematic illustration of the base 100 of the electric vehicle charging structure including a base portion 101 located at an upper part of the base 100, a base compartment 110 at a lower part of the base 100 and including a channel 140 in the base portion 101 that extends from the upper part of the base portion 101 to the base compartment 110 in some embodiments according to the inventive concept. FIG. 2A is a schematic illustration of the base 100 of the electric vehicle charging structure in FIG. 1 having the base compartment 110 and the channel 140 sealed by respective Cover A 120 and Cover B 150 to prevent the exposure of the electrical conductors that can extend along the channel 140 into the base compartment 110 in some embodiments according to the inventive concept.

According to FIG. 1, the terminal block 130 can be located in the interior of the base compartment 110. The terminal block 130 is configured to electrically couple to the wires (i.e., electrical conductors) that are run to the base compartment 110. Still further, the terminal block 130 is electrically coupled to conductors in an electrical connector 160 that passes through an upper surface 132 of the base compartment 110. It will be understood that the electrical connector 160 is located to electrically couple to a corresponding electrical connector 210 in the stepped surface of the main unit 200 when the base 100 and the main unit 200 are mated together to form the electric vehicle charging structure in some embodiments according to the inventive concept. It will be understood that the upper and lower surfaces 132 and 131 can have any shape including be planar, curved, or the like.

In some embodiments according to the inventive concept, the terminal block 130 may be compatible with commercially available types and provide for termination of the wires. The terminal block 130 may be pre-wired via a circuit board or other structure to a male or female connector 160, in a manner that prevents electrical arcing or shorting and can accommodate 120 volts or 240 volts and up to 50 Amps of electric current.

As further shown in FIG. 1, in some embodiments according to the inventive concept the base compartment 110 includes a lower surface 131 that is opposite the upper surface 132 both of which can protrude orthogonal to a front surface 102 of the base portion 101. The electrical connector 160 extends through the upper surface 132 at a specific location that is configured to allowing mating with the electrical connector 210 on the stepped surface of the main unit 200.

As shown in FIGS. 1 and 2A, the base 100 can include conduit entry holes 105 in the base compartment 110 and/or in the base portion 101 to allow the insertion of conduit and wire from either the sides, top, bottom, and back of the base 100. Unused holes 105 can have plugs 106 to prevent incursion of moisture or dust.

In some embodiments according to the inventive concept, the base 100 includes channel 140 and the Cover B 150, to allow the conduit and wiring to come from a different side (top is shown). The wiring can be then run in the channel 140 to the base compartment 110, and sealed with Cover B 150, which can provide appropriate physical and moisture protection. It will be appreciated by those of ordinary skill in the art given the benefit of the present disclosure that use of embodiments according to the inventive concept can provide (a) access to wiring from all sides, (b) easy installation without electronics or receptacles in the way, and (c) protection of wires against abrasion, moisture, or dust, which can result in a safer installation and/or at lower labor cost.

The interior of the base compartment 110 may be accessible via the holes 105 to allow the wires to be conveniently packed and connected to terminal blocks 130 located therein. In some embodiments according to the inventive concept, the Cover A 120 can be placed over the opening of the base compartment 110 to protect the wiring. It will be appreciated by those of ordinary skill in the art given the benefit of the present disclosure that the use of some embodiments according to the inventive concept can allow the wiring and packing to be performed without the receptacles or other electronics etc. obstructing (physically and/or visually) the installer. Still further embodiments according to the inventive concept can also reduce the risk of accidental damage to any electronics, given that the electronics (in the main unit 200) are not present when the wiring is performed. In some embodiments according to the inventive concept, the base 100 includes an integrated heat sink for cooling of power electronics mounted to the base 100 and/or inside the main unit 200.

In some embodiments according to the inventive concept, the base 100 can include slots, prongs, pins or holes 170 to facilitate the secure attachment to the main unit 200, with a screw or other mechanism to prevent casual removal of the main unit 200. As shown in FIGS. 1 and 2A, in some embodiments according to the inventive concept, the base 100 can include slots 170 that can allow the insertion attachment prongs 220 of the main unit 200 so that the main unit 200 can slide down onto the base 100 to form the electric vehicle charging structure. The sliding process can cause the connectors 160 and 210 in the base 100 and main unit 200 to mate/unmate. In other embodiments according to the inventive concept, pins can be inserted into guide-holes using a “push insertion” instead of the sliding type shown with prongs and slots 170. The base 100 may be fabricated from either plastic (e.g., ABS, polycarbonate, etc.), metal. Other materials can also be used.

Still referring to FIGS. 1 and 2, first and second ribs 192 can be located at the upper portion of the base portion 101 and can each be aligned to the side surfaces 141 of the channel 140. In some embodiments according to the inventive concept, the ribs 192 protrude away from the front surface 102 of the base portion 101 and are shaped to conform to the interior shape of the slot in the rear surface of the main unit 200.

FIG. 2B is a schematic illustration of the base 100 of an electric vehicle charging structure in FIG. 2A including a cap 190 that covers an electrical connector 160 that supplies power from inside the base compartment 110 in some embodiments according to the inventive concept. According to FIG. 2B, the cap 190 includes a horizontal portion 193 that can secured to the upper surface 132 of the base compartment 110. Still further, the cap 190 can also include a first vertical portion 193 that can be secured to the base portion 101 opposite the Cover B 150. The cap 190 can also include a second vertical portion 194 that extends across the cover A 120 to a tab 197 at the lower end of the base compartment 110. It will be understood that the cap 190 can prevent the intrusion of foreign matter into the electrical connector 160 until the main unit 200 is ready for mating with the base 100.

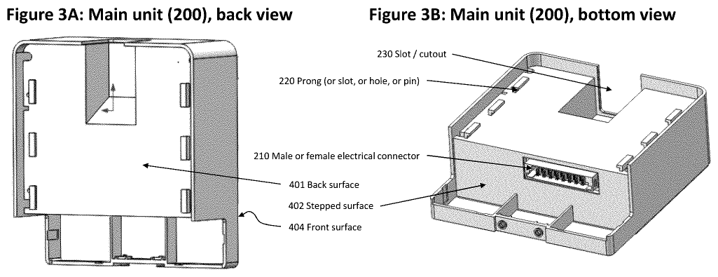

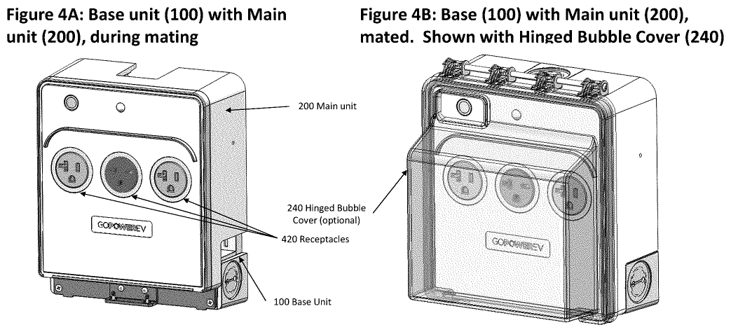

FIGS. 3A and 3B are schematic illustrations of a back surface of a main unit 200 of the electric vehicle charging structure including an electrical connector 210 on a stepped surface 402 thereof that is configured to mate with the electrical connector 160 of the base compartment 110 shown in FIGS. 1-2 to form the assembled electric vehicle charging structure in some embodiments according to the inventive concept. As shown in FIGS. 3A and 3B, the main unit 200 includes a back surface 401 that extends opposite a front surface 404 of the main unit 402 to the stepped surface 402. The back surface 401 can also include a slot 230 that is shaped to house the ribs 106 therein. The front surface 404 can include the receptacles 420 of the electric vehicle charging structure (as shown for example, in FIGS. 4A and 4B).

As further shown in FIGS. 4A and 4B, the base 100 can be mounted at a charging location and pre-wired by the electrical contractor so that the electrical service is connected to the electrical connector 160 via the terminal block 130 inside the base compartment 110. According to FIG. 4B, when the main unit 200 is slid or pushed into position over the base 100, the electrical service wired to the terminal block 130 is electrically coupled to the receptacles 420 through the mated electrical connectors 160 and 210. Main unit 200 includes one or more of the receptacles 420, and may include other electronics. Main unit 200 includes wiring to connect the receptacles either directly or indirectly to the male/female connector 210. As further shown in FIG. 4B, the main unit 200 can be covered by a cover 240 that is configured to be seal the front surface 404 of the main unit 200 that includes the receptacle 420. The cover 240 can include hinges that allow the cover 240 to be swung away from the front surface 404 to allow access to the receptacles 420.

In some embodiments of the inventive concept, the main unit 200 is assembled with one or more receptacles and sealed prior to the installation process. Once the base 100 is installed, the electric installer only needs to push, slide, or insert main unit 200 such that the male/female connectors mate appropriately.

If the main unit 200 fails or breaks, the main unit can be replaced without removing the base and without altering the wiring connections which can reduce labor when compared to conventional outlet & receptacles, which may require re-wiring in the case of replacement.

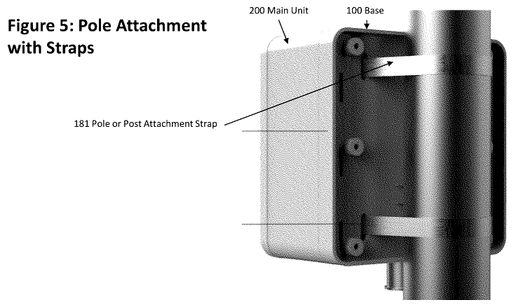

FIG. 5, in some embodiments according to the inventive concept, the base 100 includes straps 181 to facilitate mounting to a pole or post. In some embodiments according to the inventive concept, multiple Pole or Post Strap Slots 180 can be used to accommodate various size (diameter or width) poles, posts, or pillars.

Conditional language, such as, among others, “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Unless the context clearly requires otherwise, throughout the description and the claims, the words “include,” “can include,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number, respectively. The word “or” in reference to a list of two or more items, covers all of the following interpretations of the word: any one of the items in the list, all of the items in the list, and any combination of the items in the list. Likewise the term “and/or” in reference to a list of two or more items, covers all of the following interpretations of the word: any one of the items in the list, all of the items in the list, and any combination of the items in the list.

Depending on the embodiment, certain operations, acts, events, or functions of any of the routines described elsewhere herein can be performed in a different sequence, can be added, merged, or left out altogether (non-limiting example: not all are necessary for the practice of the algorithms). Moreover, in certain embodiments, operations, acts, functions, or events can be performed concurrently, rather than sequentially.

These and other changes can be made to the inventive concept in light of the above Detailed Description. While the above description describes certain examples of the inventive concept, and describes the best mode contemplated, no matter how detailed the above appears in text, the inventive concept can be practiced in many ways. Details of the system may vary considerably in its specific implementation, while still being encompassed by the inventive concept disclosed herein. As noted above, particular terminology used when describing certain features or aspects of the inventive concept should not be taken to imply that the terminology is being redefined herein to be restricted to any specific characteristics, features, or aspects of the inventive concept with which that terminology is associated. In general, the terms used in the following claims should not be construed to limit the inventive concept to the specific examples disclosed in the specification, unless the above Detailed Description section explicitly defines such terms. Accordingly, the actual scope of the inventive concept encompasses not only the disclosed examples, but also all equivalent ways of practicing or implementing the inventive concept under the claims.

Disjunctive language such as the phrase “at least one of X, Y, or Z,” unless specifically stated otherwise, is otherwise understood with the context as used in general to present that an item, term, etc., may be either X, Y, or Z, or any combination thereof (non-limiting examples: X, Y, and/or Z). Thus, such disjunctive language is not generally intended to, and should not, imply that certain embodiments require at least one of X, at least one of Y, or at least one of Z to each be present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described elsewhere herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

Any terms generally associated with circles, such as “radius” or “radial” or “diameter” or “circumference” or “circumferential” or any derivatives or similar types of terms are intended to be used to designate any corresponding structure in any type of geometry, not just circular structures. For example, “radial” as applied to another geometric structure should be understood to refer to a direction or distance between a location corresponding to a general geometric center of such structure to a perimeter of such structure; “diameter” as applied to another geometric structure should be understood to refer to a cross sectional width of such structure; and “circumference” as applied to another geometric structure should be understood to refer to a perimeter region. Nothing in this specification or drawings should be interpreted to limit these terms to only circles or circular structures.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in the Figures is turned over, elements described as being on the “lower” side of other elements would then be oriented on “upper” sides of the other elements. The exemplary term “lower”, can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

In the drawings and specification, there have been disclosed exemplary embodiments of the inventive concept. However, many variations and modifications can be made to these embodiments without substantially departing from the principles of the present inventive concept. Accordingly, although specific terms are used, they are used in a generic and descriptive sense only and not for purposes of limitation, the scope of the inventive concept being defined by the following claims.

What is claimed:

1. An electric vehicle charging structure comprising:
a base portion including a front surface and a rear surface;
a base compartment that is rigidly coupled to the base portion, the base compartment defined by a base compartment upper surface and a base compartment lower surface that each protrude away from the front surface of the base portion;
an electrical connector passing through the base compartment upper surface at a specified location;
a conduit entry opening in the base compartment configured to allow insertion of electrical service conductors to inside the base compartment;
a power terminal inside the base compartment, the power terminal configured to removably secure the electrical service conductors; and
an internal electrical conductor inside the base compartment electrically coupling the power terminal to the electrical connector.

2. The electric vehicle charging structure of claim 1 wherein the base portion includes a plurality of attachment openings configured to receive respective attachment protrusions of a main unit that is configured to mate with the base portion via the electrical connector.

3. The electric vehicle charging structure of claim 1 wherein the internal electrical conductor is included on a printed circuit board.

4. The electric vehicle charging structure of claim 3 wherein the power terminal is mounted on the printed circuit board.

5. The electric vehicle charging structure of claim 1 wherein the base portion includes a plurality of strap slots extending through the base portion.

6. The electric vehicle charging structure of claim 1 wherein the base portion includes a channel recessed into the front surface of the base portion and extending from an upper edge of the base portion to beneath the base compartment upper surface.

7. The electric vehicle charging structure of claim 6 further comprising:
a first removeable cover enclosing the channel.

8. The electric vehicle charging structure of claim 1 further comprising:
a second removeable cover coupled to the base compartment upper and lower surfaces to enclose the base compartment.

9. The electric vehicle charging structure of claim 6 wherein the conduit entry opening comprises a first conduit entry opening, the structure further comprising:
a second conduit entry opening proximate to an upper end of the base portion;
a first rib protruding from front surface of the base portion on a first side of the second conduit entry opening aligned to a first side surface the channel;
a second rib protruding from front surface of the base portion on a second side of the second conduit entry opening aligned to a second side surface the channel.

10. The electric vehicle charging structure of claim 9 further comprising:
a removeable cover extending conformally over the channel from the base compartment upper surface conforming to the first and second ribs to end at the second conduit entry opening.

11. The electric vehicle charging structure of claim 1 wherein the electrical connector comprises a first electrical connector at a first specified location and the conduit entry opening comprises a first conduit entry opening, the structure further comprising:
a main unit comprising:
a back surface configured to removably mate in close contact with the front surface of the base portion, the back surface of the main unit including a slot located opposite, and shaped to allow insertion of, a first rib and a second rib and a second conduit entry opening in the slot;
a stepped surface extending horizontally from the back surface; and
a second electrical connector extending through the stepped surface to an interior of the main unit at a second specified location that is configured to removably mate in close contact with the first electrical connector.

12. The electric vehicle charging structure of claim 1 further comprising a gasket located between the front surface of the base portion and the base compartment.

13. An electric vehicle charging structure comprising:
a main unit including:
a back surface configured to removably mate in close contact with a front surface of a base portion of an electric vehicle charging structure;
a slot in the back surface shaped to allow insertion of first and second ribs and a conduit entry opening of the base portion, in the slot;
a plurality of attachment openings protruding from the back surface at locations corresponding to locations of respective attachment openings in a front surface of the base portion;
a stepped surface extending horizontally from the back surface; and
a main unit electrical connector extending through the stepped surface to an interior of the main unit at a specified location corresponding to a location of a base portion electrical connector, wherein the main unit electrical connector is configured to electrically couple to electrical service conductors secured to a power terminal of the base portion.

14. The electric vehicle charging structure of claim 13 further comprising:
an electrical receptacle extending through a front surface of the main unit, the electrical receptacle electrically coupled to conductors included in the main unit electrical connector to provide power at the electrical receptacle when the main unit is coupled to the base portion of the electric vehicle charging structure via the main unit electrical connector coupled to the base portion electrical connector.

15. An electric vehicle charging structure comprising:
a base portion of the electric vehicle charging structure having a front surface that includes a base portion electrical connector facing in an upward direction at a first location configured to provide electrical power at the base portion electrical connector upon installation; and
a main unit of the electric vehicle charging structure having a back surface that includes a main unit electrical connector surface facing in downward direction that is opposite to the upward direction at a second location so that the main unit electrical connector and the base portion electrical connector mate together into close contact when the main unit of the electric vehicle charging structure is lowered onto the base portion.

16. The electric vehicle charging structure of claim 15 further comprising:
a plurality of attachment openings in the front surface of the base portion; and
a plurality of attachment protrusions protruding from the back surface of the main unit, wherein the plurality of attachment openings and the plurality of attachment protrusions are located to mate together in close contact when the main unit of the electric vehicle charging structure is coupled to the base portion.
